(19) United States
(12) Patent Application Publication
(10) Pub. No.: US 2002/0149285 A1
(43) Pub. Date: Oct. 17, 2002

(54) Brushless DC motor with axial winding/axial air gap

(75) Inventors: Alex Horng, Kaohsiung (TW); Yin Tso-Kuo, Kaohsiung Hsien (TW)

Correspondence Address: Bacon & Thomas, 625 Slaters Lane - 4th Floor, Alexandria, VA, 22314, US

(73) Assignee: Sunonwealth Electric Machine Industry Co., Ltd., Kaohsiung (TW)

(21) Appl. No.: 09/829,929

(22) Filed: Apr. 11, 2001

(51) Int. Cl. H02K 1/12

(52) U.S. Cl. 310/254; 310/261

(57) ABSTRACT

A brushless DC motor comprises a pole through which an end of a magnetically conductive tube that is fixed to a tube on a casing extends. A bobbin includes a central hole through which the magnetically conductive tube extends. The bobbin has a winding wound therearound, the winding having terminals electrically connected to contacts of a drive device. A central shaft of a rotor is rotatably mounted in the magnetically conductive tube. A round top of the rotor has a magnetic disc securely attached thereto. A metal disc is mounted between the magnet disc and the round top of the rotor. The magnet disc and the pole edges of the pole and the pole edges of the magnetically conductive tube are repulsive to each other, and the drive device varies polarities of the pole edges to thereby drive the rotor.

### BACKGROUND OF THE INVENTION

1. Field of the Invention

The present invention relates to a brushless direct current (DC) motor with axial winding and axial air gap for easy assembly. The motor has a rotor with a magnet having a small axial height and the rotation of the rotor is more stable with a low noise.

2. Description of the Related Art

FIGS. 7 and 8 illustrate a conventional brushless DC motor with axial winding and radial air gap. The motor comprises a casing 90 with an axle tube 91 around which a circuit board 92 and a bobbin 93 are mounted. The bobbin 93 includes an upper pole plat 94 and a lower pole plate 95 to form a stator for induction with a magnet ring 97 attached to a rotor 96, thereby be driving the rotor 96.

Such a conventional brushless DC motor is easy to assemble. However, the magnet ring 97 on the rotor 96 has a certain axial height as a result of the radial air gap between the magnet ring 97 and the upper and lower pole plates 94 and 95. It is, thus, not easy to obtain stable and precise rotation for the rotor 96 and noise occurs accordingly.

### SUMMARY OF THE INVENTION

It is the primary object of the present invention to provide a brushless DC motor with axial winding and axial air gap, wherein the motor has a simple structure for easy assembly.

It is the secondary object of the present invention to provide a brushless DC motor with axial winding and axial air gap for providing stable rotation for the rotor and reducing the rotational noise.

A brushless DC motor with axial winding and axial air gap in accordance with the present invention comprises a pole comprising a plurality of first pole edges and a positioning hole. An end of a magnetically conductive tube is extended through the positioning hole of the pole in an intimate contact manner and fixed to a tube on a casing. The other end of the magnetically conductive tube has a plurality of second pole edges having a number the same as that of the first pole edges. The first pole edges and the second pole edges are alternately located with respect to each other. A bobbin includes a central hole through which the magnetically conductive tube extends. The bobbin has a winding wound therearound. The winding has a plurality of terminals electrically connected to a plurality of contacts of a drive means that includes a plurality of control elements and a plurality of sensing elements. A rotor includes a round top from which a central shaft extends. The central shaft is rotatably mounted in the magnetically conductive tube. The round top of the rotor has a magnetic disc securely attached thereto. A metal disc is mounted between the magnet disc and the round top of the rotor. The magnet disc and the first pole edges of the pole and the second pole edges of the magnetically conductive tube are repulsive to each other, and the drive means varies polarities of the first pole edges and the second pole edges to thereby drive the rotor.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is an exploded perspective view of a first embodiment of a brushless DC motor in accordance with the present invention.

FIG. 2 is a top view of the brushless DC motor in FIG. 1.

FIG. 3 is a sectional view taken along line 3-3 in FIG. 2.

FIG. 4 is an exploded perspective view of a second embodiment of the brushless DC motor in accordance with the present invention.

FIG. 5 is a top view of the brushless DC motor in FIG. 4.

FIG. 6 is a sectional view taken along line 6-6 in FIG. 5.

FIG. 7 is an exploded perspective view of a conventional brushless DC motor with axial winding and radial air gap.

FIG. 8 is a sectional view of the conventional brushless DC motor in FIG. 7.

### DETAILED DESCRIPTION OF THE PREFERRED EMBODIMENTS

Preferred embodiments in accordance with the present invention will now be described with reference to the accompanying drawings.

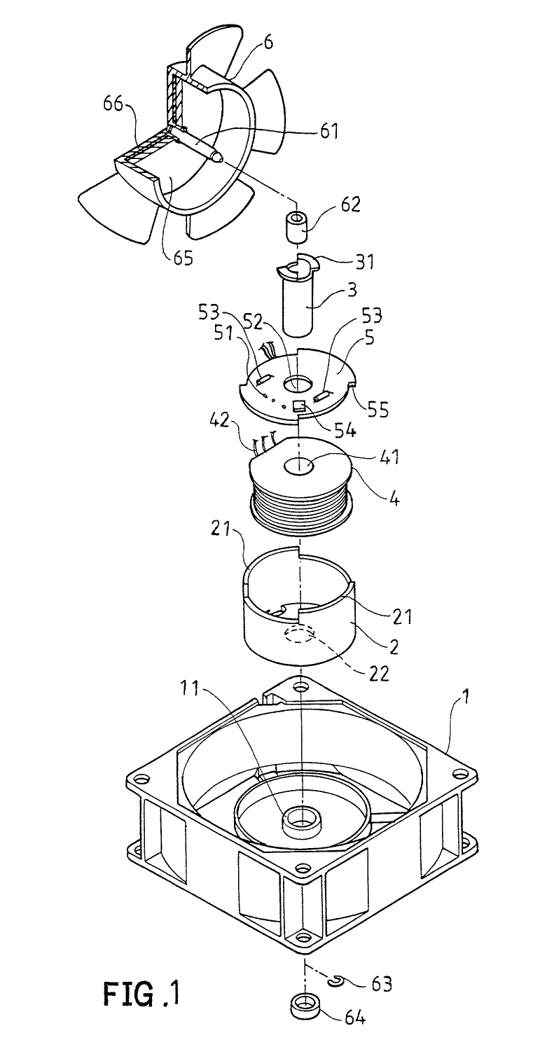

Referring to FIG. 1, a first embodiment of a brushless DC motor with axial winding and axial air gap in accordance with the present invention generally includes a casing 1, a pole 2, a magnetically conductive tube 3, a bobbin 4, a circuit board 5, and a rotor 6.

The casing 1 houses all of the elements and may be a casing for a motor or fan. The casing 1 comprises a tube 11 into which a lower end of the magnetically conductive tube 3 is inserted. It is noted that the tube 11 may have a longer dimension without adversely affecting its function.

The pole 2 is made from magnetically conductive material. The pole 2 includes at least two pole edges 21 according to the design need. A positioning hole 22 is defined in a bottom of the pole 2 for engaging with an end of the magnetically conductive tube 3.

The magnetically conductive tube 3 is made from magnetically conductive material. An end of the magnetically conductive tube 3 extends through a central hole 52 of the circuit board 5, a central hole 41 of the bobbin 4, and the positioning hole 22 of the pole 2 and then engaged in the tube 11 of the casing 1. The magnetically conductive tube 3 is fittingly mounted in the central hole 52 of the circuit board 5, the central hole 41 of the bobbin 4, and the positioning hole 22 of the pole 2 by, e.g., slight difference in diameters. Namely, the outer diameter of the magnetically conductive tube 3 is slightly greater than the inner diameters of the central hole 52 of the circuit board 5, the central hole 41 of the bobbin 4, and the positioning hole 22 of the pole 2. The other end of the magnetically conductive tube 3 includes a plurality of pole edges 31 that are alternately located with respect to the pole edges 21 of the pole 2. The number of the pole edges 31 of the magnetically conductive tube 3 depends upon the number of the pole edges 21 of the pole 2.

The bobbin 4 includes an axial winding (not labeled) wound therearound. The magnetically conductive tube 3 extends through the central hole 41 of the bobbin 4, as mentioned above. If necessary, the magnetically conductive tube 3 and the central hole 41 of the bobbin 4 may be in tight engagement with each other. Terminals 42 of the winding are electrically connected with contacts 51 of a drive means on the circuit board 5.

The circuit board 5 includes control elements 53 and sensing elements 54 that together form a drive means. The drive means includes contacts 51 in contact with the terminals 42 of the winding of the bobbin 4. The magnetically conductive tube 3 extends through the central hole 52 of the circuit board 5, as mentioned above. If necessary, the magnetically conductive tube 3 and the central hole 52 of the circuit board 5 may be in tight engagement with each other. In order to provide precise location of the sensing elements 54 of the drive means of the circuit board 5, two cutouts 56 are defined in an outer periphery of the circuit board 5 to thereby define two opposite end walls 55 in each cutout 56. The end walls 55 in each cutout 56 engage with two ends of an associated pole edge 21 of the pole 2, thereby allowing easy assembly of the circuit board 5 and locating the sensing elements 54 in precise locations.

The rotor 6 includes a round top (not labeled) from which a central shaft 61 extends. The central shaft 61 is rotatably mounted in a bearing 62 in the magnetically conductive tube 3. The bearing 62 may be a conventional ball bearing or an oily bearing. The central shaft 61 may be retained in place by a retainer, such as a C-clip 63, thereby preventing disengagement of the rotor 6. If necessary, a distal end of the central shaft 61 may rest on a support piece 64 fixed to the casing 1 or the magnetically conductive tube 3, thereby providing a stable rotation for the rotor 6. The rotor 6 includes a magnet disc 65 that is secured to an inner side of the top of the rotor 6. The magnet disc 65 and the pole edges 21 and 31 respectively of the pole 2 and the magnetically conductive tube 3 are repulsive to each other. In addition, a metal plate 66 is mounted between the magnet disc 65 and the top of the rotor 6 for collecting magnetism.

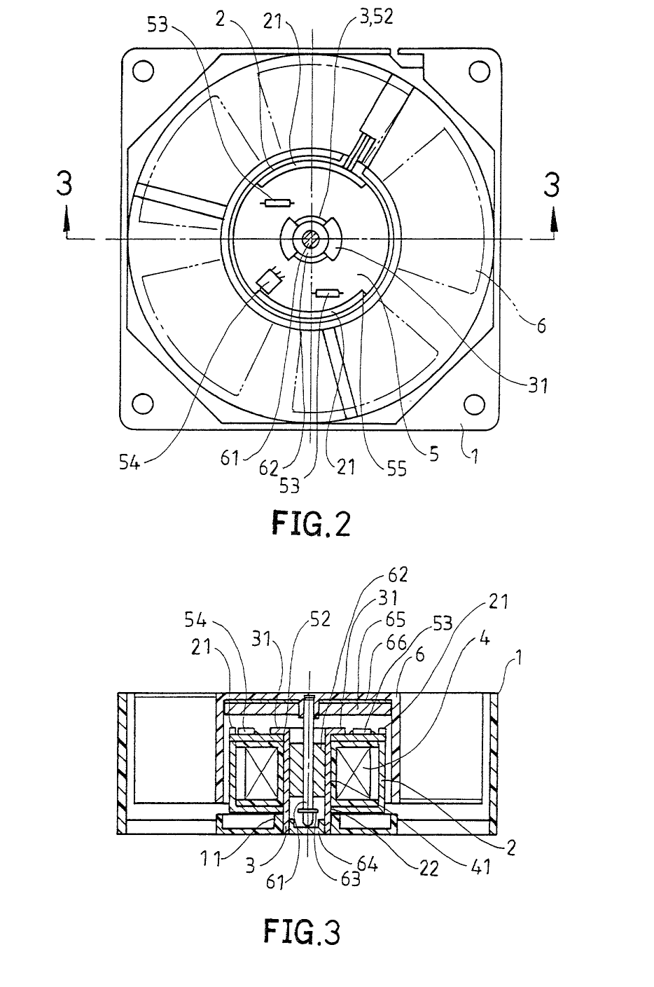

Referring to FIGS. 2 and 3 that illustrate the brushless DC motor in an assembled state, the magnetically conductive tube 3 is engaged with the circuit board 5, the bobbin 4, and the pole 2 and fixed to the tube 11 of the casing 1. The pole edges 21 of the pole 2 and the pole edges 31 of the magnetically conductive tube 3 are alternately located with each other about a common center and all of the pole edges 21 and 31 are equi-angularly spaced from each other. The magnetically conductive tube 3 has a bearing 62 mounted therein for rotatably supporting the central shaft 61 of the rotor 6. The magnet disc 65 and the pole edges 21 and 31 of the pole 2 and the magnetically conductive tube 3 are repulsive to each other. The drive means on the circuit board 5 varies polarities of the pole edges 21 and 31 to thereby drive the rotor 6.

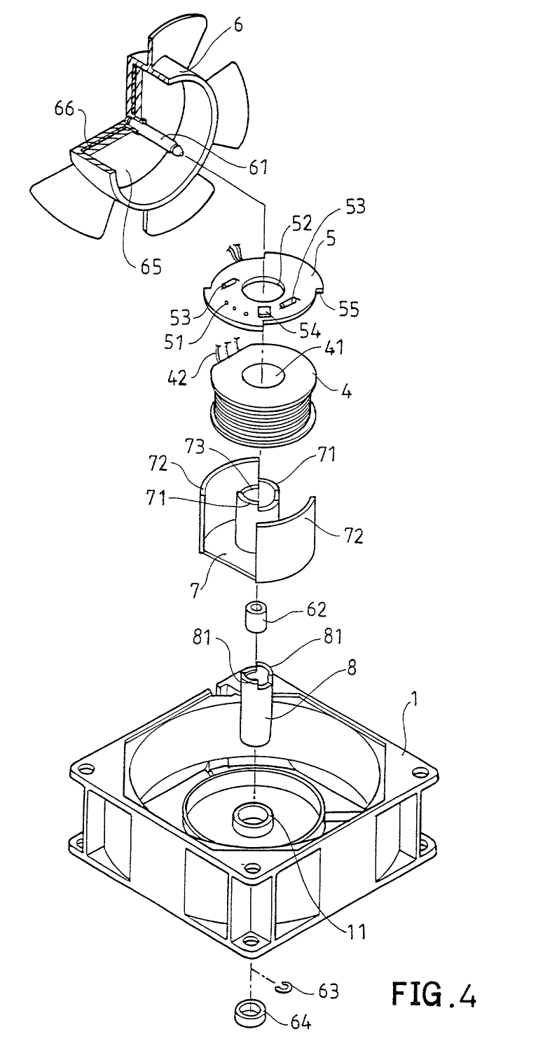

Referring to FIG. 4, a second embodiment of the brushless DC motor with axial winding and axial air gap in accordance with the present invention generally includes a casing 1, a pole 7, a magnetically conductive tube 8, a bobbin 4, a circuit board 5, and a rotor 6.

The casing 1 houses all of the elements and may be a casing for a motor or fan. The casing 1 comprises a tube 11 for engaging with a tube 73 of the pole 7 and the magnetically conductive tube 8.

The pole 7 is made from magnetically conductive material. The pole 7 includes a plurality of inner pole edges 71 and a plurality of outer pole edges 72. It is noted that the number of the pole edges is decided according to design need. The inner pole edges 71 and the outer pole edges 72 are alternately located with respect to each other about a common center and all of the pole edges 71 and 72 are equi-angularly spaced from each other. The inner pole edges 71 is formed by a tube 73 that extends upward from a bottom of the pole 7. The magnetically conductive tube 8 is inserted into the tube 73.

The magnetically conductive tube 8 is made from magnetically conductive material and has an end mounted in the tube 73 of the pole 7. Preferably, the tube 73 of the pole 7 and the magnetically conductive tube 8 are in tight engagement with each other. The other end of the magnetically conductive tube 8 includes a plurality of pole edges 81 the number of which depends on the design need. It is noted that the pole edges 81 of the magnetically conductive tube 8 and the inner pole edges 71 of the pole 7 have identical angular positions to thereby form a larger conducting area.

The bobbin 4 includes an axial winding (not labeled) wound therearound. The bobbin 4 includes a central hole 41 through which the tube 73 of the pole 7 extends. If necessary, the central hole 41 of the bobbin 4 may be in tight engagement with an outer periphery of the tube 73 of the pole 7. Terminals 42 of the winding are electrically connected with contacts 51 of a drive means on the circuit board 5.

The circuit board 5 includes control elements 53 and sensing elements 54 that together form a drive means. The drive means includes contacts 51 in contact with the terminals 42 of the winding of the bobbin 4. The circuit board 5 includes a central hole 52 through which the tube 73 of the pole 71 extends. In order to provide precise location of the sensing elements 54 of the drive means of the circuit board 5, two cutouts 56 are defined in an outer periphery of the circuit board 5 to thereby define two opposite end walls 55 in each cutout 56. The end walls 55 in each cutout 56 engage with two ends of an associated outer pole edge 72 of the pole 7, thereby allowing easy assembly of the circuit board 5 and locating the sensing elements 54 in precise locations.

The rotor 6 includes a round top (not labeled) from which a central shaft 61 extends. The central shaft 61 is rotatably mounted in a bearing 62 in the magnetically conductive tube 3. The bearing 62 may be a conventional ball bearing or an oily bearing. The central shaft 61 may be retained in place by a retainer, such as a C-clip 63, thereby preventing disengagement of the rotor 6. If necessary, a distal end of the central shaft 61 may rest on a support piece 64 fixed to the casing 1 or the magnetically conductive tube 8, thereby providing a stable rotation for the rotor 6. The rotor 6 includes a magnet disc 65 that is secured to an inner side of the top of the rotor 6. The magnet disc 65 and the inner and outer pole edges 71 and 72 and the pole edges 81 respectively of the pole 7 and the magnetically conductive tube 8 are repulsive to each other. In addition, a metal plate 66 is mounted between the magnet disc 65 and the top of the rotor 6 for collecting magnetism.

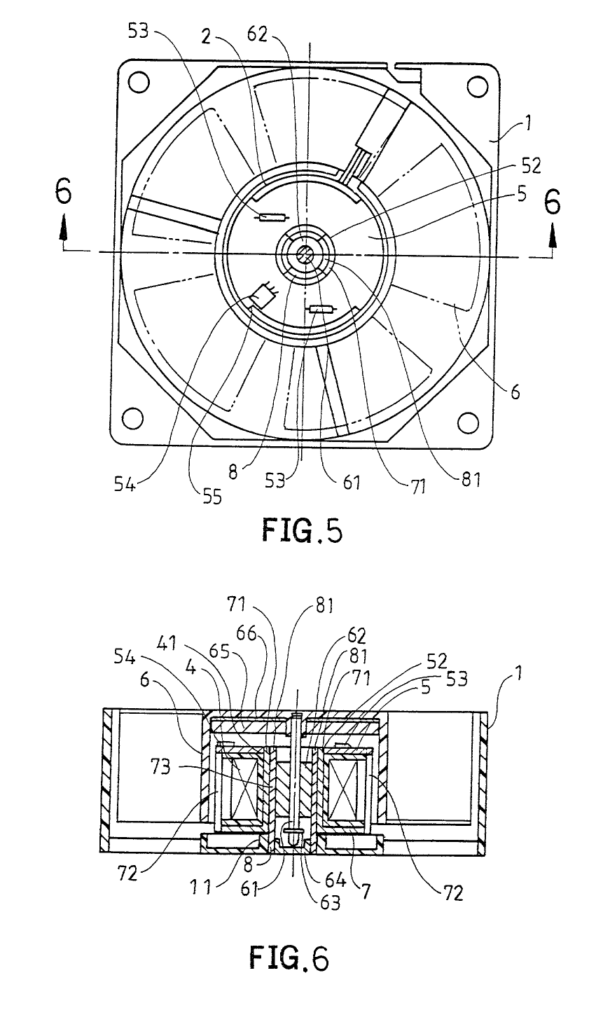

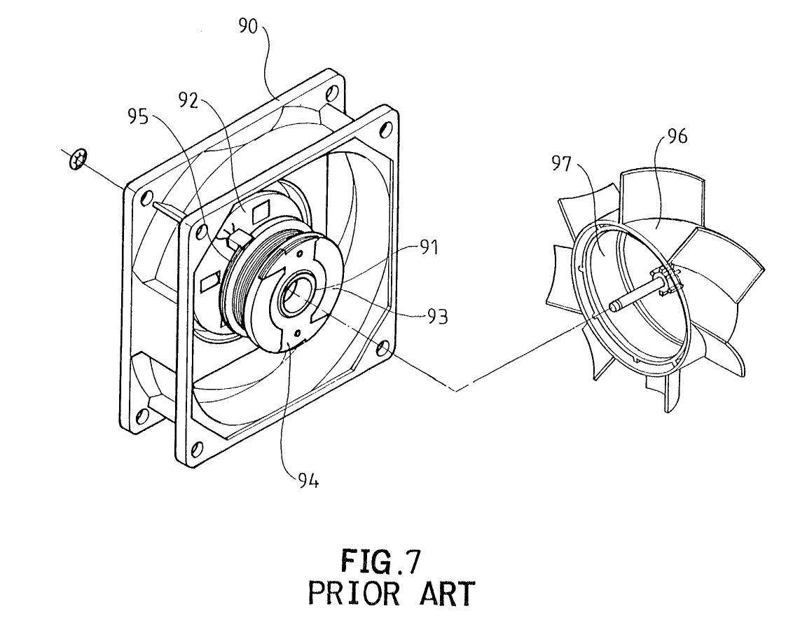

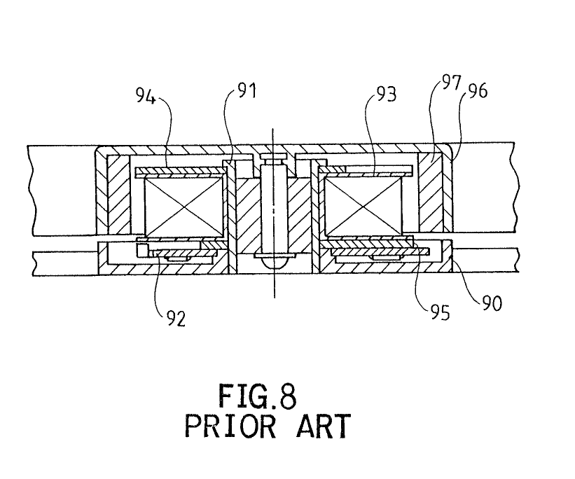

Referring to FIGS. 5 and 6 that illustrate the brushless DC motor in an assembled state, the magnetically conductive tube 8 is engaged in the tube 73 of the pole 7, and the bobbin 4 and the circuit board 5 are mounted around the tube 73 of the pole 7. An end of the magnetically conductive tube 8 is fixed in the tube 11 of the casing 1. The pole edges 81 of the magnetically conductive tube 8 and the inner pole edges 72 of the pole 7 are aligned with each other in angular positions thereof. The pole edges 81 of the magnetically conductive tube 8 and the outer pole edges 72 of the pole 7 are equi-angularly spaced from each other about a common center and alternately located with respect to each other. The magnetically conductive tube 8 has a bearing 62 mounted therein for rotatably supporting the central shaft 61 of the rotor 6. The magnet disc 65 and the pole edges 8 and the inner pole edges 71 respectively of the magnetically conductive tube 8 and the pole 7 are repulsive to each other. The drive means on the circuit board 5 varies polarities of the inner and outer pole edges 71 and 72 and the pole edges 81 to thereby drive the rotor 6.

According to the above description, it is appreciated that the brushless DC motor with axial winding and axial air gap in accordance with the present invention can be assembled easily with stable rotation of the rotor and reduced rotational noise.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A brushless DC motor with axial winding and axial air gap, comprising:
a casing;
a pole comprising a plurality of first pole edges and a positioning hole;
a magnetically conductive tube having a first end extended through the positioning hole of the pole in an intimate contact manner and fixed to the casing, the magnetically conductive tube having a second end with a plurality of second pole edges having a number the same as that of the first pole edges, the first pole edges and the second pole edges being alternately located with respect to each other;
a bobbin including a central hole through which the magnetically conductive tube extends, the bobbin having a winding wound therearound, the winding having a plurality of terminals;
a drive means including a plurality of control elements and a plurality of sensing elements, the drive means further including a plurality of contacts for electrical connection with the terminals of the bobbin; and
a rotor including a round top from which a central shaft extends, the central shaft being rotatably mounted in the magnetically conductive tube, the round top of the rotor having a magnetic-disc securely attached thereto;
wherein the magnet disc and the first pole edges of the pole and the second pole edges of the magnetically conductive tube are repulsive to each other, and the drive means varies polarities of the first pole edges and the second pole edges to thereby drive the rotor.

2. The brushless DC motor with axial winding and axial air gap as claimed in claim 1, wherein the casing includes a tube having an inner periphery for tight contact with the magnetically conductive tube, the magnetically conductive tube including a bearing mounted to an inner periphery thereof.

3. The brushless DC motor with axial winding and axial air gap as claimed in claim 1, wherein the casing includes a tube with an outer periphery, the magnetically conductive tube being mounted around the outer periphery of the tube of the casing, the tube of the casing including a bearing securely mounted to an inner periphery thereof.

4. The brushless DC motor with axial winding and axial air gap as claimed in claim 1, wherein the magnetically conductive tube is in tight engagement with the positioning hole of the pole.

5. The brushless DC motor with axial winding and axial air gap as claimed in claim 1, wherein the drive means is mounted on a circuit board, the circuit board including a central hole through which the magnetically conductive tube extends.

6. The brushless DC motor with axial winding and axial air gap as claimed in claim 5, wherein the circuit board includes a plurality of end walls for respectively engaging with two ends of each of the pole edges of the pole.

7. The brushless DC motor with axial winding and axial air gap as claimed in claim 2, wherein the tube of the casing includes a support element mounted therein for supporting a distal end of the central shaft of the rotor.

8. The brushless DC motor with axial winding and axial air gap as claimed in claim 1, wherein the round top of the rotor and the magnet disc includes a metal plate mounted therebetween.

9. A brushless DC motor with axial winding and axial air gap, comprising:
a casing;
a pole comprising a tube formed in a center thereof, the pole comprising a plurality of inner pole edges and a plurality of outer pole edges, the inner pole edges and the outer pole edges being alternately located relative to each other along an angular position, the tube of the pole being fixed to the casing;
a bobbin comprising a central hole through which the tube of the pole extends, the bobbin having a winding wound therearound, the winding having a plurality of terminals;
a magnetically conductive tube having a first end extended through the positioning hole, the bobbin having a winding wound therearound, the winding having a plurality of terminals;
a drive means including a plurality of control elements and a plurality of sensing elements, the drive means further including a plurality of contacts for electrical connection with the terminals of the bobbin; and
a rotor including a round top from which a central shaft extends, the central shaft being rotatably mounted in the tube of the pole, the round top of the rotor having a magnetic disc securely attached thereto;
wherein the magnet disc and the inner pole edges and outer pole edges of the pole are repulsive to each other, and the drive means varies polarities of the inner pole edges and the outer pole edges to thereby drive the rotor.

10. The brushless DC motor with axial winding and axial air gap as claimed in claim 9, wherein the casing includes a tube having an inner periphery for tight contact with the tube of the pole, the tube of the pole including a bearing mounted to an inner periphery thereof.

11. The brushless DC motor with axial winding and axial air gap as claimed in claim 9, wherein the round top of the rotor and the magnet disc includes a metal plate mounted therebetween.

12. The brushless DC motor with axial winding and axial air gap as claimed in claim 9, wherein the drive means is mounted on a circuit board, the circuit board including a central hole through which the tube of the pole extends.

13. The brushless DC motor with axial winding and axial air gap as claimed in claim 9, wherein the circuit board includes a plurality of end walls for respectively engaging with two ends of each of the outer pole edges of the pole.

14. The brushless DC motor with axial winding and axial air gap as claimed in claim 10, wherein the tube of the casing includes a support element mounted therein for supporting a distal end of the central shaft of the rotor.

15. The brushless DC motor with axial winding and axial air gap as claimed in claim 9, further comprising a magnetically conductive tube mounted in the tube of the pole.

16. The brushless DC motor with axial winding and axial air gap as claimed in claim 15, wherein the magnetically conductive tube includes a plurality of pole edges having a number the same as that of the inner pole edges of the pole, the pole edges of the magnetically conductive tube and the inner pole edges of the pole being aligned with each other in angular positions thereof.

17. The brushless DC motor with axial winding and axial air gap as claimed in claim 15, wherein the magnetically conductive tube is in tight engagement with an inner periphery of the tube of the pole.
